(19) United States
(12) Patent Application Publication
(10) Pub. No.: US 2025/0023992 A1
(43) Pub. Date: Jan. 16, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Junya YAMADA, Kanagawa (JP)

(73) Assignee: FUJIFILM Business Innovation Corp., Tokyo (JP)

(21) Appl. No.: 18/429,434

(22) Filed: Feb. 1, 2024

(30) Foreign Application Priority Data
Jul. 11, 2023 (JP) 2023-113698

(51) Int. Cl. H04N 1/00; H04N 1/44

(52) U.S. Cl. CPC H04N 1/00875; H04N 1/4413; H04N 2201/0094

(57) ABSTRACT

An information processing system includes one or plural processors configured to: when an event of starting a direct operation for an image processing apparatus has occurred, display predetermined identification information on the image processing apparatus; and restrict remote operations for the image processing apparatus performed by terminals other than a terminal that has read the identification information.

### CROSS-REFERENCE TO RELATED APPLICATIONS

This application is based on and claims priority under 35 USC 119 from Japanese Patent Application No. 2023-113698 filed Jul. 11, 2023.

### BACKGROUND

### (i) Technical Field

The present disclosure relates to an information processing system, an information processing method, and a non-transitory computer readable medium.

### (ii) Related Art

A technique for connecting a remote terminal to an image processing apparatus, such as a so-called multifunction machine, capable of printing and reading of documents and other types of processing so that the remote terminal is capable of remotely operating the image processing apparatus has been known (for example, Japanese Unexamined Patent Application Publication No. 2015-207875). Such a technique allows the remote terminal to perform an operation for reading a document set on the image processing apparatus and an operation for acquiring information about the read document.

### SUMMARY

However, if reading of a document by a remote operation by the remote terminal is permitted without any restriction, information about the document set on the image processing apparatus may be acquired by anyone who uses the remote terminal to perform the remote operation. In this case, the information about the document set on the image processing apparatus may be leaked through the remote terminal.

Aspects of non-limiting embodiments of the present disclosure relate to preventing information about a document set on an image processing apparatus from being leaked through a remote terminal.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or a plurality of processors configured to: when an event of starting a direct operation for an image processing apparatus has occurred, display predetermined identification information on the image processing apparatus; and restrict remote operations for the image processing apparatus performed by terminals other than a terminal that has read the identification information.

### BRIEF DESCRIPTION OF THE DRAWINGS

Exemplary embodiments of the present disclosure will be described in detail based on the following figures, wherein:

FIG. 1 is a diagram illustrating an example of the entire configuration of an information processing system according to an exemplary embodiment;

FIG. 2 is a diagram illustrating an example of the hardware configuration of an image processing apparatus;

FIG. 3 is a diagram illustrating an example of the functional configuration of a controller of the image processing apparatus;

FIG. 4 is a diagram illustrating an example of the functional configuration of a controller of a user terminal;

FIG. 5 is a flowchart illustrating the flow of a process of the image processing apparatus;

FIG. 6 is a flowchart illustrating the flow of a process of the user terminal;

FIG. 7 is a diagram illustrating a specific example of user interfaces displayed on the image processing apparatus and the user terminal;

FIG. 8A is a diagram illustrating a specific example of a remote operation screen displayed on the user terminal when the image processing apparatus is not capable of executing a job designated by a user; and

FIG. 8B is a diagram illustrating a specific example of the case where identification information displayed on the image processing apparatus is displayed in a switched manner.

### DETAILED DESCRIPTION

Hereinafter, exemplary embodiments of the present disclosure will be described in detail with reference to the attached drawings.

### <Configuration of Information Processing System>

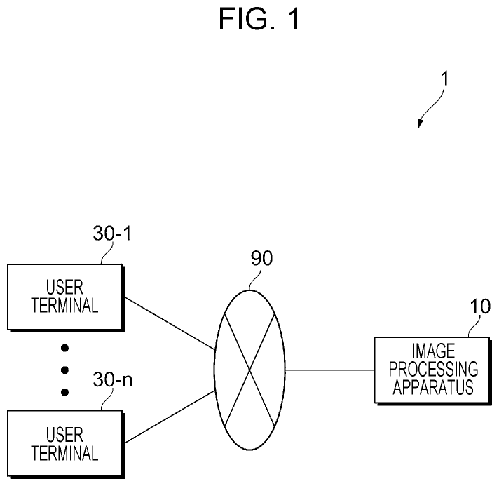

FIG. 1 is a diagram illustrating an example of the entire configuration of an information processing system 1 according to an exemplary embodiment.

The information processing system 1 is configurated in such a manner that an image processing apparatus 10 and user terminals 30-1 to 30-n (n represents an integer of 1 or more) are connected via a network 90. The network 90 is, for example, a local area network (LAN), the Internet, or the like. Hereinafter, in the case where there is no need to describe the user terminals 30-1 to 30-n separately, they will be collectively referred to as “user terminals 30”.

### (Image Processing Apparatus)

The image processing apparatus 10 is an information processing apparatus that performs various types of processing in accordance with input operations performed by a user who uses the information processing system 1. For example, the image processing apparatus 10 performs printing processing for forming an image on a medium such as paper and performing output, copy processing for copying an image of a document on a medium such as paper and performing output, reading processing for reading an image formed on paper or other media, facsimile processing for transmitting a document by facsimile transmission, and the like. The image processing apparatus 10 is, for example, a multifunction machine of a so-called electrophotographic system that forms a toner image on a printing surface of paper, a printer of a so-called inkjet system that discharges ink to a printing surface of paper, or the like.

The image processing apparatus 10 displays a user interface, receives an input operation for the user interface, and acquires input information based on the input operation. Input operations for the user interface include a direct operation and a remote operation. The direct operation is a direct input operation for the user interface displayed on the image processing apparatus 10 that is performed by a user who faces the image processing apparatus 10. The remote operation is an indirect input operation for the user interface of the image processing apparatus 10 displayed in a shared manner on a user terminal 30 that is performed by a user who operates the user terminal 30 that is remotely connected to the image processing apparatus 10.

Furthermore, the image processing apparatus 10 acquires various types of information transmitted from each of the user terminals 30 and performs various types of processing. For example, the image processing apparatus 10 receives an instruction to execute a job from a user and executes the job. A “job” represents a unit of predetermined processing (for example, printing processing for forming an image on a medium such as paper and performing output, copy processing for copying an image of a document on a medium such as paper and performing output, reading processing for reading an image formed on paper or other media, facsimile processing for transmitting a document by facsimile transmission, or the like) executed by the image processing apparatus 10. Furthermore, the image processing apparatus 10 transmits various types of information to each of the user terminals 30.

For example, when an event of starting a direct operation for the image processing apparatus 10 has occurred, the image processing apparatus 10 displays identification information on the image processing apparatus 10. The “event of starting a direct operation for the image processing apparatus 10” represents approach of an object (for example, a person), setting of a document, or the like. When displayed identification information is read by a user terminal 30, the image processing apparatus 10 restricts remote operations for the image processing apparatus 10 performed by terminals other than the user terminal 30. Specifically, the image processing apparatus 10 performs authentication based on reading information transmitted from the user terminal 30 that has read the displayed identification information and restricts remote operations for the image processing apparatus 10 performed by terminals other than the user terminal 30 that has read the identification information.

“Identification information” represents, for example, information such as QR code (registered trademark) in which information for uniquely identifying the image processing apparatus 10 (hereinafter, referred to as “apparatus information”), information for performing authentication to use the image processing apparatus 10 (hereinafter, referred to as “authentication information”), and the like are associated.

The image processing apparatus 10 that displays identification information restricts remote operations for the image processing apparatus 10 performed by terminals other than a user terminal 30 that has read the identification information and has been authenticated based on authentication information associated with the identification information. The identification information that the image processing apparatus 10 displays is one-time identification information in which associated authentication information is updated every time that the identification information is displayed. Authentication information associated with identification information that is displayed one time on the image processing apparatus 10 is unused authentication information. Thus, a remote operation is not executable using identification information associated with used authentication information.

After identification information is displayed, when a predetermined condition is satisfied, the image processing apparatus 10 displays in a switched manner the identification information whose associated authentication information has been updated. For example, the “predetermined condition” is that a job designated by a user terminal 30 that has read identification information displayed on the image processing apparatus 10 has been executed, a request for authentication has been made by a user terminal 30 that has read identification information displayed on the image processing apparatus 10, or the like.

After identification information is displayed, when a direct operation for the image processing apparatus 10 is started and then completed, the image processing apparatus 10 restricts a remote operation for the image processing apparatus 10 performed by a user terminal 30 that has read the identification information. Furthermore, after identification information is displayed, in the case where a direct operation for the image processing apparatus 10 is not started, the image processing apparatus 10 restricts a remote operation for the image processing apparatus 10 performed by a user terminal 30 that has read the identification information.

In this case, for example, when the image processing apparatus 10 detects that a person has moved away from the image processing apparatus 10 or a direct operation for the image processing apparatus 10 has been completed, the image processing apparatus 10 may determine that the direct operation for the image processing apparatus 10 has been completed or a direct operation for the image processing apparatus 10 is not started. Furthermore, when the image processing apparatus 10 detects that a document has been removed from the image processing apparatus 10, the image processing apparatus 10 may determine that the direct operation for the image processing apparatus 10 has been completed or a direct operation for the image processing apparatus 10 is not started.

In the case where the image processing apparatus 10 is not capable of executing a job designated by a user terminal 30, the image processing apparatus 10 displays on the user terminal 30 information indicating that the designated job is not executable (hereinafter, referred to as “non-executable information”). Furthermore, in the case where the image processing apparatus 10 is not capable of executing a job designated by a user terminal 30, the image processing apparatus 10 displays on the user terminal 30 information for being capable of executing the designated job (hereinafter, referred to as “handling information”).

Furthermore, in the case where the image processing apparatus 10 is not capable of executing a job designated by a user terminal 30, the image processing apparatus 10 displays on the user terminal 30 information regarding a job that is not the designated job and is executable by the image processing apparatus 10 (hereinafter, referred to as “alternative job information”). Details of a configuration and a process of the image processing apparatus 10 will be described later.

### (User Terminals)

Each of the user terminals 30 is an information processing apparatus, such as a smartphone, a tablet terminal, or a personal computer, that is operated by a user who uses the information processing system 1. Application software for allowing the user terminal 30 to remotely operate the image processing apparatus 10 is installed on the user terminal 30.

The user terminal 30 acquires various types of information transmitted from the image processing apparatus 10 and performs various types of processing. The user terminal 30 also transmits various types of information to the image processing apparatus 10. For example, the user terminal 30 displays in a shared manner a user interface of the remotely connected image processing apparatus 10. The user terminal 30 also receives an input operation for the user interface that is displayed in a shared manner and acquires input information about the input operation.

For example, when an input operation for causing the image processing apparatus 10 to execute a job, as an input operation for the user interface that is displayed in a shared manner, is performed, the user terminal 30 transmits the input information to the image processing apparatus 10. Furthermore, the user terminal 30 reads identification information displayed on the image processing apparatus 10 and transmits the reading information to the image processing apparatus 10, as a request for authentication to use the image processing apparatus 10.

Furthermore, the user terminal 30 acquires control information transmitted from the image processing apparatus 10, and performs various types of processing based on the control information. For example, after the user terminal 30 transmits input information for executing a job to the image processing apparatus 10, when control information for displaying non-executable information is transmitted to the user terminal 30, the user terminal 30 displays the non-executable information based on the control information.

Furthermore, when control information for displaying information for allowing the image processing apparatus 10 to be capable of executing a job is transmitted to the user terminal 30, the user terminal 30 displays, based on the control information, the information for allowing the image processing apparatus 10 to be capable of executing the job. Furthermore, when control information for displaying alternative job information is transmitted to the user terminal 30, the user terminal 30 displays the alternative job information based on the control information. Details of a configuration and a process of the user terminal 30 will be described later.

The configuration of the information processing system 1 described above is merely an example. The information processing system 1 in its entirety needs to have functions for executing the processing described above. Thus, part of or all the functions for executing the processing described above may be shared or cooperated in the information processing system 1. That is, part of or all the functions of a user terminal 30 may be provided in the image processing apparatus 10 or part of or all the functions of the image processing apparatus 10 may be provided in the user terminal 30. Furthermore, part of or all the functions of the user terminal 30 and the image processing apparatus 10 that configurate the information processing system 1 may be transferred to other servers not illustrated in drawings. Thus, processing as the entire information processing system 1 may be promoted and a plurality of types of processing may complement each other.

### <Hardware Configuration of Image Processing Apparatus>

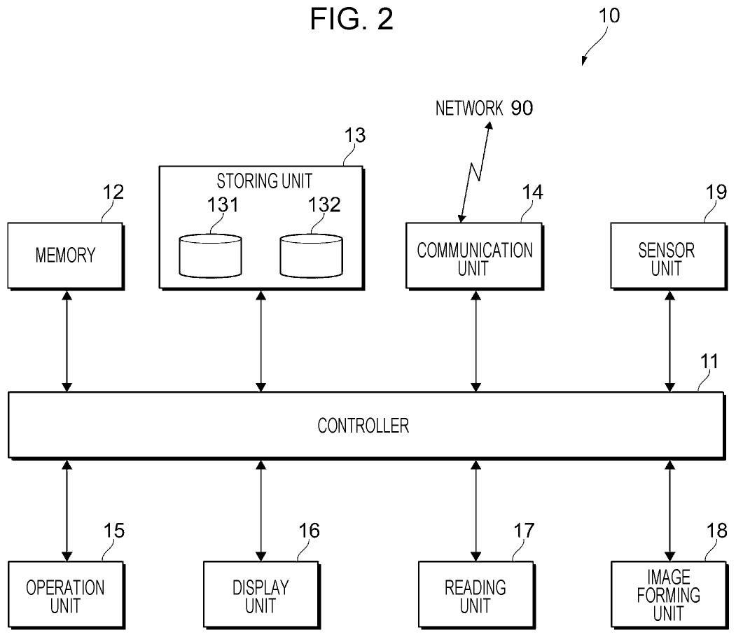

FIG. 2 is a diagram illustrating an example of the hardware configuration of the image processing apparatus 10.

The image processing apparatus 10 includes a controller 11, a memory 12, a storing unit 13, a communication unit 14, an operation unit 15, a display unit 16, a reading unit 17, an image forming unit 18, and a sensor unit 19. These units are connected by a data bus, an address bus, a peripheral component interconnect (PCI) bus, or the like.

The controller 11 is a processor that controls functions of the image processing apparatus 10 through execution of various types of software such as operating software (OS) and application software. The controller 11 includes, for example, a central processing unit (CPU). The memory 12 is a storage region in which various types of software and data used for execution of the various types of software are stored and is used as a work area for calculation. The memory 12 includes, for example, a random access memory (RAM).

The storing unit 13 is a storage region in which data to be input to various types of software, data output from various types of software, and the like are stored. The storing unit 13 includes, for example, a hard disk drive (HDD), a solid state drive (SSD), a semiconductor memory, or the like used for storing programs and various types of setting data. For example, as databases in which various types of information are stored, an apparatus DB 131 in which apparatus information is stored, an authentication DB 132 in which authentication information is stored, and the like are provided in the storing unit 13.

The communication unit 14 performs transmission and reception of data to and from the user terminals 30 and other devices via the network 90. The operation unit 15 includes, for example, a software keyboard, mechanical buttons, switches, and the like and receives input operations. The operation unit 15 also includes a touch sensor that forms a touch panel to be integrated with the display unit 16. The display unit 16 includes, for example, a liquid crystal display or an organic electroluminescence (EL) display used for displaying information and displays data of images, text, and the like.

The reading unit 17 reads an image recorded on a medium such as paper as a recording medium (for example, a document of a paper medium). The reading unit 17 includes, for example, a scanner of a charge coupled devices (CCD) type that reduces, with a lens, reflected light with respect to light radiated from a light source to a document and receives, with CCD, the light, a scanner of a contact image sensor (CIS) type that receives, with a CIS, reflected light with respect to light sequentially radiated from a light-emitting diode (LED) light source to a document, or the like. Furthermore, the reading unit 17 reads, using a camera, information about an image (for example, QR code (registered trademark)) displayed on the display unit 16.

The image forming unit 18 forms, for example, using an electrophotographic system or an inkjet system, an image as a printing target on a printing surface of paper as a recording medium. The sensor unit 19 includes various sensors such as a motion sensor, an environmental light sensor, a proximity sensor, a light sensor such as light detection and ranging (LiDAR), an acceleration sensor, and the like and detects a direct operation for the image processing apparatus 10 performed by a user.

### <Hardware Configuration of User Terminals>

The hardware configuration of each of the user terminals 30 is similar to the hardware configuration of the image processing apparatus 10 illustrated in FIG. 2 with the exception of the image forming unit 18 and the sensor unit 19. That is, the user terminal 30 includes a controller, a memory, a storing unit, a communication unit, an operation unit, a display unit, and a reading unit that have functions similar to functions of the controller 11, the memory 12, the storing unit 13, the communication unit 14, the operation unit 15, the display unit 16, and the reading unit 17 in FIG. 2, and illustration in drawings and description of these units are omitted.

### <Functional Configuration of Controller of Image Processing Apparatus>

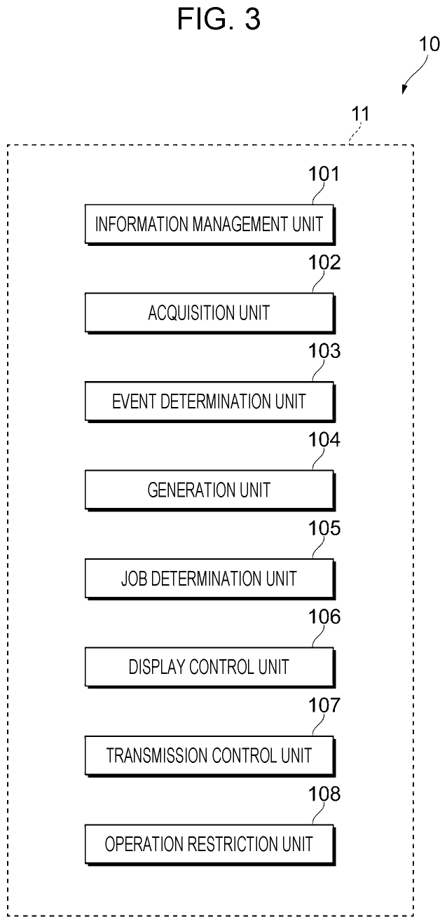

FIG. 3 is a diagram illustrating an example of the functional configuration of the controller 11 of the image processing apparatus 10.

In the controller 11 of the image processing apparatus 10, an information management unit 101, an acquisition unit 102, an event determination unit 103, a generation unit 104, a job determination unit 105, a display control unit 106, a transmission control unit 107, and an operation restriction unit 108 function.

The information management unit 101 stores various types of information into databases of the storing unit 13 (see FIG. 2) and manages the various types of information. For example, the information management unit 101 stores apparatus information into the apparatus DB 131 and manages the apparatus information. The apparatus information contains, for example, information capable of uniquely identifying the image processing apparatus 10. The information capable of uniquely identifying the image processing apparatus 10 is, for example, a uniform resource locator (URL) for accessing the image processing apparatus 10, an email address, a service set identifier (SSID), or the like. Furthermore, the information management unit 101 stores authentication information into the authentication DB 132 and manages the authentication information. The authentication information is, for example, an authentication ID, a password, or the like generated one time.

The acquisition unit 102 acquires various types of information. For example, the acquisition unit 102 acquires various types of information transmitted from the user terminals 30. Information transmitted from the user terminals 30 includes, for example, reading information about identification information displayed on the image processing apparatus 10, input information input to execute a job, and the like.

The event determination unit 103 determines whether or not an event of starting a direct operation for the image processing apparatus 10 has occurred. The determination as to whether or not the event of starting a direct operation has occurred is made by determining whether or not an event of approach of an object (for example, a person) or setting of a document has occurred. Specifically, the event determination unit 103 detects, based on a sensing result by the sensor unit 19 (see FIG. 2), approach of an object, setting of a document, or the like and determines whether or not an event of starting a direct operation for the image processing apparatus 10 has occurred.

The generation unit 104 generates identification information to be displayed on the image processing apparatus 10. Specifically, the generation unit 104 generates QR code as identification information in which apparatus information and authentication information are associated. The generation unit 104 generates one-time identification information in which associated authentication information is updated every time that the identification information is displayed on the image processing apparatus 10.

The job determination unit 105 determines whether or not a job designated by a user terminal 30 that has read identification information displayed on the image processing apparatus 10 has been executed. Specifically, the job determination unit 105 determines, based on histories of jobs executed by the image processing apparatus 10, whether the designated job has been executed.

The display control unit 106 performs control for displaying various types of information on the display unit 16 (see FIG. 2). For example, the display control unit 106 performs control for displaying a user interface on the display unit 16. The display control unit 106 also performs control for displaying identification information on the display unit 16.

Furthermore, the display control unit 106 performs control for displaying various types of information on the display unit of each of the user terminals 30. For example, the display control unit 106 performs control for displaying in a shared manner, on the display unit of the user terminal 30, the user interface displayed on the display unit 16. Furthermore, the display control unit 106 performs control for displaying non-executable information on the display unit of the user terminal 30. The display control unit 106 also performs control for displaying handling information on the display unit of the user terminal 30. Furthermore, the display control unit 106 performs control for displaying alternative job information on the display unit of the user terminal 30.

The transmission control unit 107 performs control for transmitting various types of information via the communication unit 14 (see FIG. 2). For example, the transmission control unit 107 performs control for transmitting various types of information to each of the user terminals 30. The information transmitted to each of the user terminals 30 is, for example, control information for causing the user terminal 30 to perform various types of processing.

The control information for causing the user terminal 30 to perform various types of processing includes, for example, control information for displaying in a shared manner on the display unit of the user terminal 30 the user interface displayed on the display unit 16 of the image processing apparatus 10, control information for displaying non-executable information, control information for displaying handling information, control information for displaying alternative job information, and the like.

The operation restriction unit 108 restricts a remote operation for the image processing apparatus 10. For example, the operation restriction unit 108 restricts remote operations for the image processing apparatus 10 performed by terminals other than a user terminal 30 that has read displayed identification information. Furthermore, the operation restriction unit 108 restricts remote operations for the image processing apparatus 10 performed by terminals other than a user terminal 30 that has read identification information displayed on the image processing apparatus 10 and has been authenticated based on authentication information associated with the identification information.

Furthermore, after identification information is displayed, when a direct operation for the image processing apparatus 10 is started and then completed, the operation restriction unit 108 restricts a remote operation for the image processing apparatus 10 performed by the user terminal 30 that has read the identification information. Furthermore, after identification information is displayed, in the case where a direct operation for the image processing apparatus 10 is not started, the operation restriction unit 108 restricts a remote operation for the image processing apparatus 10 performed by the user terminal 30 that has read the identification information.

### <Functional Configuration of Controller of User Terminals>

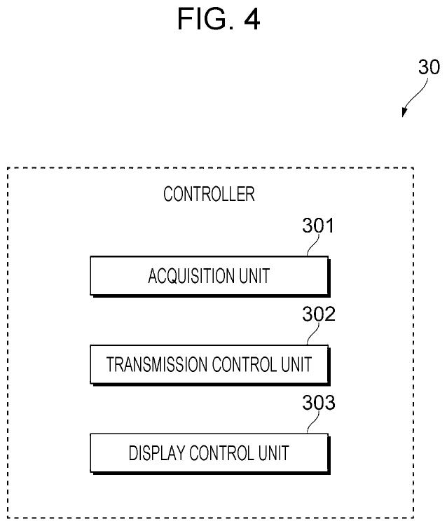

FIG. 4 is a diagram illustrating an example of the functional configuration of the controller of each of the user terminals 30.

In the controller of the user terminal 30, an acquisition unit 301, a transmission control unit 302, and a display control unit 303 function.

The acquisition unit 301 acquires various types of information. For example, the acquisition unit 301 acquires input information received by the operation unit of the user terminal 30. Furthermore, the acquisition unit 301 acquires identification information read by the reading unit of the user terminal 30. The acquisition unit 301 also acquires various types of information transmitted from the image processing apparatus 10. The information transmitted from the image processing apparatus 10 is, for example, control information for causing the user terminal 30 to perform various types of processing.

The transmission control unit 302 performs control for transmitting various types of information via the communication unit. For example, the transmission control unit 302 performs control for transmitting various types of information to the image processing apparatus 10. The information transmitted to the image processing apparatus 10 is, for example, input information acquired by the acquisition unit 301. The input information acquired by the acquisition unit 301 and transmitted to the image processing apparatus 10 is, for example, reading information obtained by reading identification information displayed on the image processing apparatus 10, input information input to execute a job, or the like.

The display control unit 303 performs control for displaying various types of information on the display unit. For example, the display control unit 303 performs control for displaying in a shared manner on the display unit of the user terminal 30 a user interface displayed on the display unit 16 of the image processing apparatus 10 (see FIG. 2). Furthermore, the display control unit 303 performs control for displaying non-executable information on the display unit. The display control unit 303 also performs control for displaying handling information. Furthermore, the display control unit 303 performs control for displaying alternative job information. Specifically, the display control unit 303 displays, based on the control information acquired by the acquisition unit 301, the information mentioned above on the display unit.

### <Flow of Process of Image Processing Apparatus>

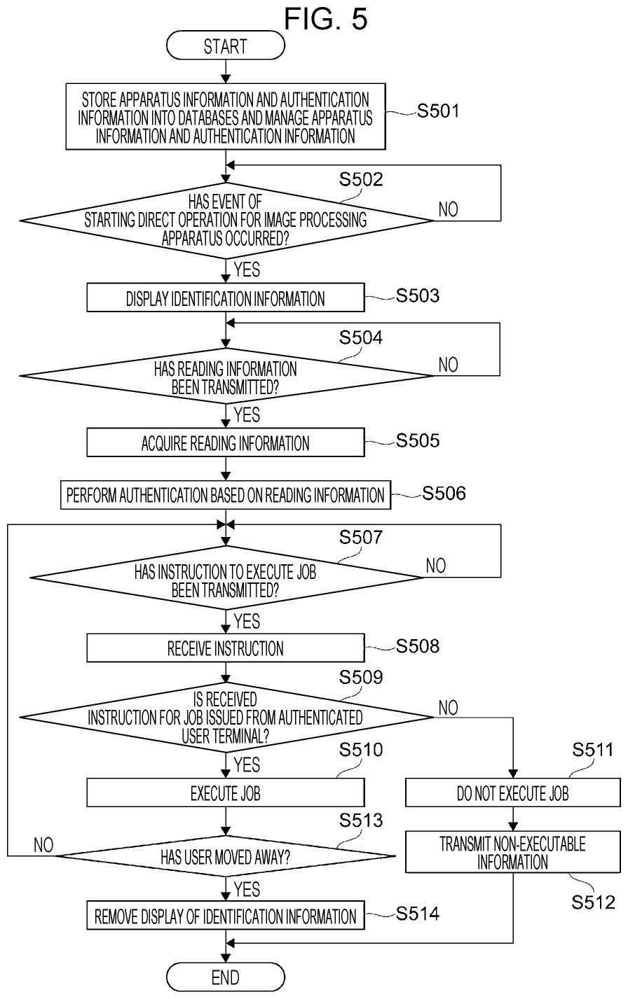

FIG. 5 is a flowchart illustrating the flow of a process of the image processing apparatus 10.

The image processing apparatus 10 stores apparatus information and authentication information into databases and manages the apparatus information and the authentication information (step 501). Specifically, the image processing apparatus 10 stores apparatus information into the apparatus DB 131 of the storing unit 13 (see FIG. 2) and manages the apparatus information, and stores authentication information into the authentication DB 132 and manages the authentication information.

When an event of starting a direct operation for the image processing apparatus 10 has occurred (YES in step 502), the image processing apparatus 10 displays identification information on the display unit 16 (see FIG. 2) of the image processing apparatus 10 (step 503), and proceeds to determination processing of step 504. In contrast, in the case where the event of starting a direct operation for the image processing apparatus 10 has not occurred (NO in step 502), the image processing apparatus 10 repeats the determination processing of step 502.

When, as a request for authentication from a user terminal 30 that has read the identification information, reading information obtained by reading the identification information is transmitted to the image processing apparatus 10 (YES in step 504), the image processing apparatus 10 acquires the transmitted reading information (step 505). Then, the image processing apparatus 10 performs authentication based on the acquired reading information (step 506). Specifically, the image processing apparatus 10 performs authentication of the user terminal 30, based on apparatus information and authentication information associated with the identification information identified from the acquired reading information, and transmits information indicating that authentication of the user terminal 30 has been performed to the user terminal 30. In contrast, in the case where no reading information is transmitted to the image processing apparatus 10 (NO in step 504), the image processing apparatus 10 repeats the determination processing of step 504 until reading information is transmitted to the image processing apparatus 10.

When an instruction to execute a job is transmitted from the user terminal 30 to the image processing apparatus 10 (YES in step 507), the image processing apparatus 10 receives the instruction (step 508), and proceeds to determination processing of step 509. In contrast, in the case where no instruction to execute a job is transmitted from the user terminal 30 to the image processing apparatus 10 (NO in step 507), the image processing apparatus 10 repeats the determination processing of step 507 until an instruction to execute a job is transmitted.

In the case where the instruction for the job received in step 508 is an instruction for a job from the user terminal 30 that has been authenticated in step 506 (YES in step 509), the image processing apparatus 10 executes the job received in step 508 (step 510), and proceeds to determination processing of step 513. In contrast, in the case where the instruction for the job received in step 508 is not an instruction for a job from the user terminal 30 that has been authenticated in step 506 (NO in step 509), the image processing apparatus 10 does not execute the designated job (step 511), transmits non-executable information to the user terminal 30 that has designated the job (step 512), and ends the process (END).

When a user who performed the direct operation for the image processing apparatus 10 has moved away (YES in step 513), the image processing apparatus 10 removes display of the identification information (step 514), and ends the process (END). In contrast, in the case where the user who performed the direct operation for the image processing apparatus 10 has not moved away (NO in step 513), the image processing apparatus 10 returns to the determination processing of step 507.

### <Flow of Process of User Terminals>

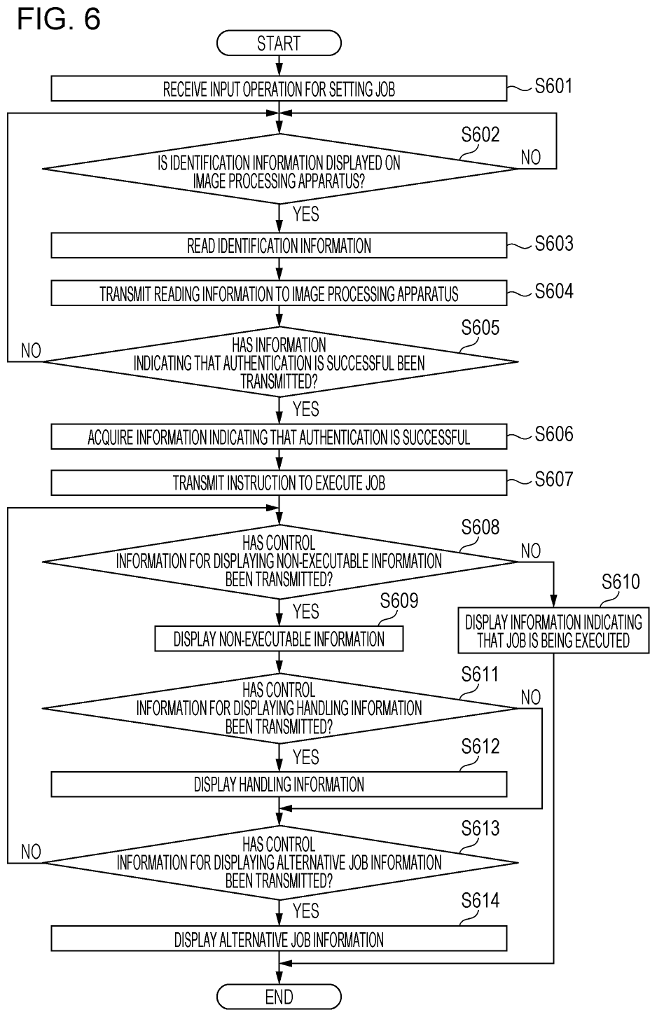

FIG. 6 is a flowchart illustrating the flow of a process of a user terminal 30.

The user terminal 30 receives an input operation for setting a job to be executed by the image processing apparatus 10 (step 601). When a user has approached the image processing apparatus 10 and identification information is displayed on the image processing apparatus 10 (YES in step 602), the user terminal 30 reads, based on a user operation, the identification information displayed on the image processing apparatus 10 (step 603), transmits the reading information to the image processing apparatus 10 as a request for authentication (step 604), and proceeds to determination processing of step 605. In contrast, in the case where identification information is not displayed on the image processing apparatus 10 (NO in step 602), the user terminal 30 repeats the determination processing of step 602 until identification information is displayed on the image processing apparatus 10.

When information indicating that authentication is successful is transmitted from the image processing apparatus 10 to the user terminal 30 (YES in step 605), the user terminal 30 acquires the information (step 606), and transmits an instruction to execute the job to the image processing apparatus 10 (step 607). Then, the user terminal 30 proceeds to determination processing of step 608. In contrast, in the case where information indicating that authentication is not successful is transmitted from the image processing apparatus 10 to the user terminal 30 (NO in step 605), the user terminal 30 returns to the determination processing of step 602.

When control information for displaying non-executable information is transmitted from the image processing apparatus 10 to the user terminal 30 (Yes in step 608), the user terminal 30 displays the non-executable information (step 609), and proceeds to determination processing of step 611. In contrast, when control information for displaying information indicating that the job is being executed is transmitted from the image processing apparatus 10 to the user terminal 30 (NO in step 608), the user terminal 30 displays the information indicating that the job is being executed (step 610), and ends the process (END).

When control information for displaying handling information is transmitted from the image processing apparatus 10 to the user terminal 30 (YES in step 611), the user terminal 30 displays the handling information (step 612). In contrast, in the case where control information for displaying handling information is not transmitted from the image processing apparatus 10 to the user terminal 30 (NO in step 611), the user terminal 30 proceeds to determination processing of step 613.

When control information for displaying alternative job information is transmitted from the image processing apparatus 10 to the user terminal 30 (YES in step 613), the user terminal 30 displays the alternative job information (step 614), and ends the process (END). In contrast, in the case where control information for displaying alternative job information is not transmitted from the image processing apparatus 10 to the user terminal 30 (NO in step 613), the user terminal 30 returns to the determination processing of step 608.

### Specific Example

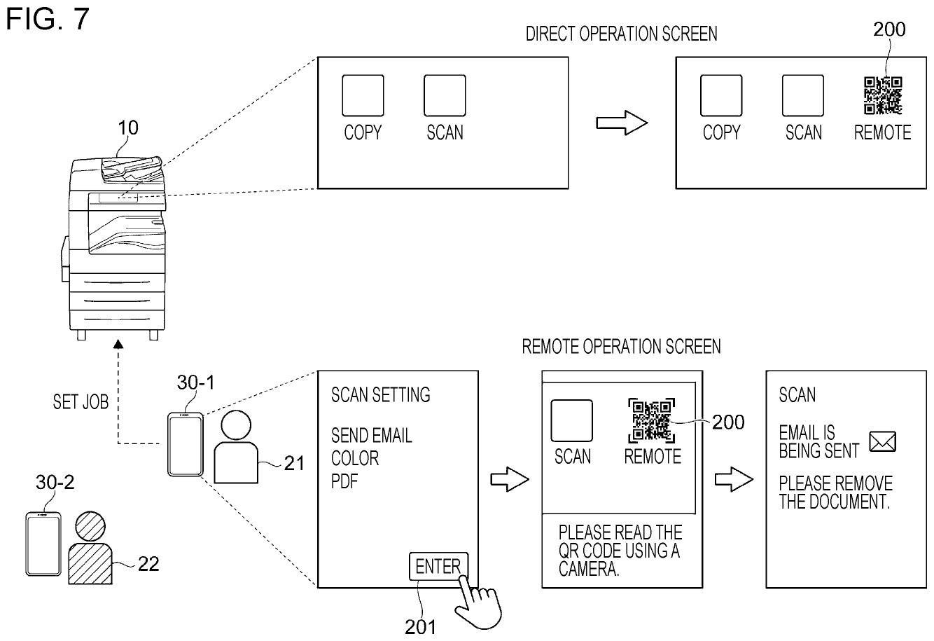

FIG. 7 is a diagram illustrating a specific example of user interfaces displayed on the image processing apparatus 10 and a user terminal 30.

A specific example of a user interface displayed on the image processing apparatus 10 (hereinafter, referred to as a “direct operation screen”) is illustrated in an upper part of FIG. 7. A specific example of a user interface displayed on a user terminal 30 (hereinafter, referred to as a “remote operation screen”) is illustrated in a lower part of FIG. 7.

A user 21 operates the user terminal 30-1 to perform setting of a job that the user 21 wishes the image processing apparatus 10 to execute, and issues an instruction to execute the job. For example, in the case where a job that the user 21 wishes the image processing apparatus 10 to execute is a job for reading processing, setting information illustrated in FIG. 7 is displayed on the remote operation screen. That is, “Scan setting” indicating that the displayed screen is a screen for setting reading processing, “Send email”, “Color”, and “PDF” indicating details of the settings of the job for the reading processing are displayed. The user 21 confirms the details of the settings of the job for the reading processing, and presses an “Enter” button 201. Thus, an instruction to execute the job is transmitted to the image processing apparatus 10.

When the user 21 has approached the image processing apparatus 10, the image processing apparatus 10 detects approach of the user 21, and displays identification information. At this time, in the case where a plurality of image processing apparatuses 10 are present near the user 21, the user 21 may choose an available image processing apparatus 10 and approach the available image processing apparatus 10. In the example of the direct operation screen illustrated in FIG. 7, a screen displayed before approach of the user 21 is detected is illustrated on a left hand side, and a screen displayed after approach of the user 21 is detected is illustrated on a right hand side. On the screen displayed after approach of the user 21 is detected (illustrated on the right hand side), QR code as identification information 200 is displayed along with “Remote” indicating that the QR code is identification information for performing a remote operation.

The user 21 operates the user terminal 30-1 to read the identification information displayed on the direct operation screen. Specifically, the user 21 performs an operation for activating a camera of the user terminal 30-1 and an operation for displaying the identification information 200 on the remote operation screen. At this time, a message “Please read the QR code using a camera.” illustrated in FIG. 7 may be displayed on the remote operation screen.

The user terminal 30-1 reads the identification information 200 displayed on the remote operation screen, and transmits the reading information to the image processing apparatus 10. Then, authentication is performed by the image processing apparatus 10, and the job for the reading processing is executed. At this time, on the remote operation screen, for example, “Scan”, “Email is being sent”, a message “Please remove the document.” are displayed, as illustrated in FIG. 7.

The valid period may be set for the identification information 200 displayed on the image processing apparatus 10. In this case, even in the case where the user terminal 30-1 reads the identification information 200, if reading information is transmitted after a predetermined time has passed since display of the identification information 200, authentication based on the reading information of the identification information 200 is not performed. Furthermore, a remote operation performed by the user terminal 30-2 of a user 22 who has not read the identification information 200 displayed on the image processing apparatus 10 is restricted. Even in the case where the user 22 operates the user terminal 30-2 to read the identification information 200, if the reading of the identification information 200 is performed after reading by the user terminal 30-1, a remote operation performed by the user terminal 30-2 is restricted.

The identification information 200 displayed on the image processing apparatus 10 becomes invalid when the user 21 has moved away from the front of the image processing apparatus 10. Thus, even if the user 21 performs imaging of the identification information 200 and stores the imaged identification information 200 in the user terminal 30, the identification information 200 becomes invalid when the user 21 has moved away from the front of the image processing apparatus 10, and the user terminal 30 is not able to be authenticated based on the stored identification information 200. The period during which the identification information 200 generated and displayed by the image processing apparatus 10 is valid is, for example, a period during which approach of the user 21 is detected, a period during which a document is set, or the like.

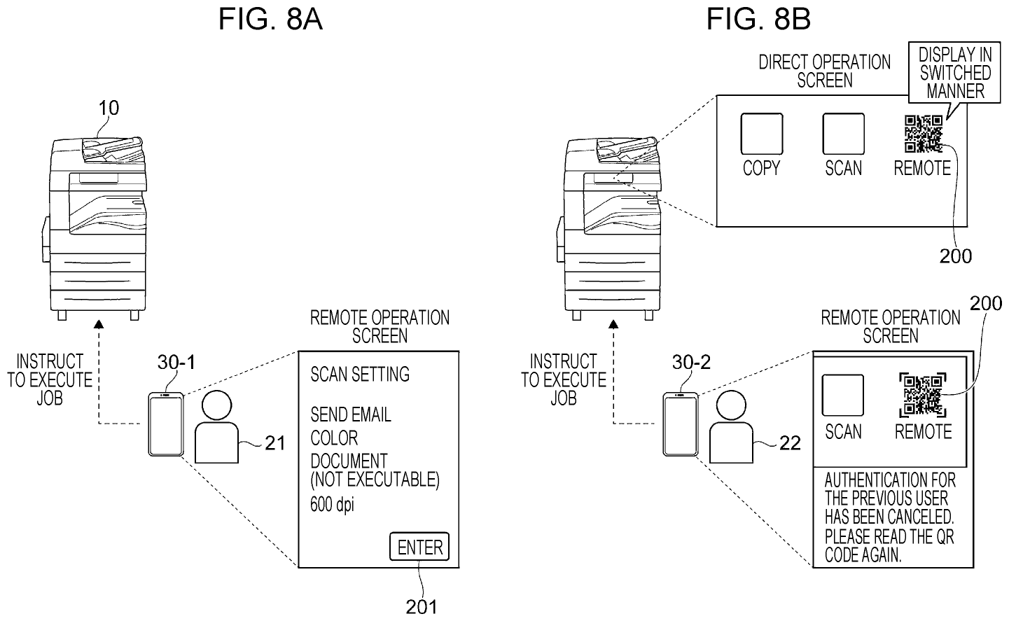

FIG. 8A is a diagram illustrating a specific example of a remote operation screen displayed on a user terminal 30 when the image processing apparatus 10 is not capable of executing a job designated by a user.

The user 21 operates the user terminal 30-1 to perform setting of a job that the user 21 wishes the image processing apparatus 10 to execute, and issues an instruction to execute the job. For example, as in the example illustrated in FIG. 7, in the case where the job that the user 21 wishes the image processing apparatus 10 to execute is a job for reading processing, if the image processing apparatus 10 is capable of executing the designated job for the reading processing without any problem, the remote operation screen illustrated in FIG. 7 is displayed. In contrast, in the case where the image processing apparatus 10 is not capable of executing the job, such as the case where the image processing apparatus 10 does not have a capability of executing the designated job for the reading processing, for example, the remote operation screen illustrated in FIG. 8A is displayed.

That is, as illustrated in FIG. 8A, for example, “Document (not executable)” indicating that the job is not executable because a document format is not supported is displayed. In this case, even if the user 21 presses the “Enter” button 201, since the image processing apparatus 10 is not capable of executing the job, error is displayed. The user 21 may change setting of the job for the reading processing so that the job for the reading processing becomes executable. Although not illustrated in the drawings, handling information or alternative job information as well as information indicating that the job is not executable may be displayed on the remote operation screen.

FIG. 8B is a diagram illustrating a specific example of the case where the identification information 200 displayed by the image processing apparatus 10 is displayed in a switched manner.

As illustrated in FIG. 7, when the user 21 has approached the image processing apparatus 10, the image processing apparatus 10 detects approach of the user 21 and displays the identification information 200. At this time, in the case where the user 21 who was in front of the image processing apparatus 10 is replaced by the user 22 and the sensor unit 19 of the image processing apparatus 10 (see FIG. 2) does not detect that the user 21 has been replaced by the user 22, the displayed identification information 200 is not updated. In this case, even if the replaced user 22 reads the identification information 200 by using the user terminal 30-2, remote connection is restricted as described above. Thus, processing described below is performed in this exemplary embodiment.

That is, after displaying the identification information 200, when executing the job designated by a user terminal 30 (for example, the user terminal 30-1 illustrated in FIG. 7) that has read the identification information 200, the image processing apparatus 10 displays in a switched manner the identification information 200 whose associated authentication information is updated, as illustrated in an upper part of FIG. 8B. Furthermore, when reading information, as a request for authentication from the user terminal 30 (for example, the user terminal 30-1 illustrated in FIG. 7) that has read the identification information, is transmitted to the image processing apparatus 10, the image processing apparatus 10 displays in a switched manner the identification information 200 whose associated authentication information is updated, as illustrated in a lower part of FIG. 8B. In this case, for example, a message “Authentication for the previous user has been canceled. Please read the QR code again.” is displayed on the remote operation screen of the user terminal 30-2 of the replaced user 22.

### Other Exemplary Embodiments

The exemplary embodiment has been described above. However, the present disclosure is not limited to the exemplary embodiment described above. Furthermore, effects achieved by the present disclosure are not limited to those described in the foregoing exemplary embodiment. For example, the configuration of the information processing system 1 illustrated in FIG. 1 and the hardware configuration of the image processing apparatus 10 illustrated in FIG. 2 are merely examples provided to attain advantages of the present disclosure and are not particularly limited. Furthermore, the functional configuration of the image processing apparatus 10 illustrated in FIG. 3 and the functional configuration of each of the user terminals 30 illustrated in FIG. 4 are merely examples and are not particularly limited. As long as the information processing system 1 in FIG. 1 is provided with functions capable of executing the processing described above in its entirety, a functional configuration to be used to implement the functions is not limited to the examples in FIGS. 3 and 4.

Furthermore, orders of steps in the process of the image processing apparatus 10 illustrated in FIG. 5 and the process of the user terminal 30 illustrated in FIG. 6 are merely examples and are not particularly limited. Processing steps are not necessarily performed in the illustrated orders of steps in a chronological manner and may be performed concurrently or individually. Furthermore, the specific examples illustrated in FIGS. 7 and 8 are merely examples and are not particularly limited.

For example, in the exemplary embodiment described above, reading processing is provided as an example of processing that a user causes the image processing apparatus 10 to execute. However, the present disclosure is not limited to this example. For example, processing that a user causes the image processing apparatus 10 to execute may be printing processing for forming an image on a medium such as paper and performing output, copy processing for copying an image of a document on a medium such as paper and performing output, reading processing for reading an image formed on paper or other media, facsimile processing for transmitting a document by facsimile transmission, or the like.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or a plurality of processors configured to:
   when an event of starting a direct operation for an image processing apparatus has occurred, display predetermined identification information on the image processing apparatus; and
   restrict remote operations for the image processing apparatus performed by terminals other than a terminal that has read the identification information.
      (((2)))

The information processing system according to (((1))), wherein the one or the plurality of processors are configured to:
display on the image processing apparatus, as the identification information, information in which information about the image processing apparatus and information for authentication are associated; and
restrict remote operations for the image processing apparatus performed by terminals other than a terminal that has been authenticated based on the information for authentication among terminals that have read the identification information.
   (((3)))

The information processing system according to (((2))), wherein the one or the plurality of processors are configured to display the identification information on the image processing apparatus, the identification information being one-time identification information in which the information for authentication is updated every time that the identification information is displayed on the image processing apparatus.

(((4)))

The information processing system according to (((2))), wherein the one or the plurality of processors are configured to restrict remote operations for the image processing apparatus performed by terminals other than a terminal that has been authenticated based on the information for authentication among terminals that have read the identification information, the information for authentication being unused.

(((5)

The information processing system according to (((4))), wherein the one or the plurality of processors are configured to, after the identification information is displayed on the image processing apparatus, when a predetermined condition is satisfied, display in a switched manner on the image processing apparatus the identification information in which the information for authentication has been updated.

(((6)))

The information processing system according to (((5))), wherein the condition is that a job designated by the terminal that has read the identification information has been executed.

(((7)))

The information processing system according to (((5))), wherein the condition is that a request for authentication has been made by another terminal that has read the identification information.

(((8)))

The information processing system according to any one of (((1))) to (((7))), wherein the one or the plurality of processors are configured to, after the identification information is displayed on the image processing apparatus, when the direct operation is completed or when the direct operation is not started, restrict a remote operation for the image processing apparatus by the terminal that has read the identification information.

(((9)))

The information processing system according to (((8))), wherein the one or the plurality of processors are configured to, when a person has moved away from the image processing apparatus, determine that the direct operation is completed or the direct operation is not started.

(((10)))

The information processing system according to (((8))), wherein the one or the plurality of processors are configured to, when a document has been removed from the image processing apparatus, determine that the direct operation is completed or the direct operation is not started.

(((11)))

The information processing system according to any one of (((1))) to (((10))), wherein the one or the plurality of processors are configured to, when an object has approached the image processing apparatus, determine that the direct operation is to start.

(((12)))

The information processing system according to (((11))), wherein the one or the plurality of processors are configured to, when a person has approached the image processing apparatus, determine that the direct operation is to start.

(((13)))

The information processing system according to (((11))), wherein the one or the plurality of processors are configured to, when a document has been set on the image processing apparatus, determine that the direct operation is to start.

(((14)))

The information processing system according to any one of (((1))) to (((13))), wherein the one or the plurality of processors are configured to, in a case where the image processing apparatus is not capable of executing a job designated by the terminal that has read the identification information, display on the terminal information indicating that the image processing apparatus is not capable of executing the job designated by the terminal.

(((15)))

The information processing system according to (((14))), wherein the one or the plurality of processors are configured to display on the terminal at least one of information for allowing the image processing apparatus to execute the designated job and information about a job that is different from the designated job and is executable by the image processing apparatus.

(((16)))

A program for causing a computer to execute:
a function for, when an event of starting a direct operation for an image processing apparatus has occurred, displaying predetermined identification information on the image processing apparatus; and
a function for restricting remote operations for the image processing apparatus performed by terminals other than a terminal that has read the identification information.

What is claimed is:

1. An information processing system comprising:
one or a plurality of processors configured to:
when an event of starting a direct operation for an image processing apparatus has occurred, display predetermined identification information on the image processing apparatus; and
restrict remote operations for the image processing apparatus performed by terminals other than a terminal that has read the identification information.

2. The information processing system according to claim 1, wherein the one or the plurality of processors are configured to:
display on the image processing apparatus, as the identification information, information in which information about the image processing apparatus and information for authentication are associated; and
restrict remote operations for the image processing apparatus performed by terminals other than a terminal that has been authenticated based on the information for authentication among terminals that have read the identification information.

3. The information processing system according to claim 2, wherein the one or the plurality of processors are configured to display the identification information on the image processing apparatus, the identification information being one-time identification information in which the information for authentication is updated every time that the identification information is displayed on the image processing apparatus.

4. The information processing system according to claim 2, wherein the one or the plurality of processors are configured to restrict remote operations for the image processing apparatus performed by terminals other than a terminal that has been authenticated based on the information for authentication among terminals that have read the identification information, the information for authentication being unused.

5. The information processing system according to claim 4, wherein the one or the plurality of processors are configured to, after the identification information is displayed on the image processing apparatus, when a predetermined condition is satisfied, display in a switched manner on the image processing apparatus the identification information in which the information for authentication has been updated.

6. The information processing system according to claim 5, wherein the condition is that a job designated by the terminal that has read the identification information has been executed.

7. The information processing system according to claim 5, wherein the condition is that a request for authentication has been made by another terminal that has read the identification information.

8. The information processing system according to claim 1, wherein the one or the plurality of processors are configured to, after the identification information is displayed on the image processing apparatus, when the direct operation is completed or when the direct operation is not started, restrict a remote operation for the image processing apparatus by the terminal that has read the identification information.

9. The information processing system according to claim 8, wherein the one or the plurality of processors are configured to, when a person has moved away from the image processing apparatus, determine that the direct operation is completed or the direct operation is not started.

10. The information processing system according to claim 8, wherein the one or the plurality of processors are configured to, when a document has been removed from the image processing apparatus, determine that the direct operation is completed or the direct operation is not started.

11. The information processing system according to claim 1, wherein the one or the plurality of processors are configured to, when an object has approached the image processing apparatus, determine that the direct operation is to start.

12. The information processing system according to claim 11, wherein the one or the plurality of processors are configured to, when a person has approached the image processing apparatus, determine that the direct operation is to start.

13. The information processing system according to claim 11, wherein the one or the plurality of processors are configured to, when a document has been set on the image processing apparatus, determine that the direct operation is to start.

14. The information processing system according to claim 1, wherein the one or the plurality of processors are configured to, in a case where the image processing apparatus is not capable of executing a job designated by the terminal that has read the identification information, display on the terminal information indicating that the image processing apparatus is not capable of executing the job designated by the terminal.

15. The information processing system according to claim 14, wherein the one or the plurality of processors are configured to display on the terminal at least one of information for allowing the image processing apparatus to execute the designated job and information about a job that is different from the designated job and is executable by the image processing apparatus.

16. An information processing method comprising:
when an event of starting a direct operation for an image processing apparatus has occurred, displaying predetermined identification information on the image processing apparatus; and
restricting remote operations for the image processing apparatus performed by terminals other than a terminal that has read the identification information.

17. A non-transitory computer readable medium storing a program causing a computer to execute a process comprising:
when an event of starting a direct operation for an image processing apparatus has occurred, displaying predetermined identification information on the image processing apparatus; and
restricting remote operations for the image processing apparatus performed by terminals other than a terminal that has read the identification information.
